(19) United States
(12) Patent Application Publication
(10) Pub. No.: US 2021/0206063 A1
(43) Pub. Date: Jul. 8, 2021

(54) OFFSET SHIMS FOR PRINT DIE

(71) Applicant: HEWLETT-PACKARD DEVELOPMENT COMPANY, L.P., Houston, TX (US)

(72) Inventors: Warren Scott MARTIN, Vancouver, WA (US); Miguel ALVAREZ, Vancouver, WA (US); Steven E. REINHART, Corvallis, OR (US)

(73) Assignee: HEWLETT-PACKARD DEVELOPMENT COMPANY, L.P., Houston, TX (US)

(21) Appl. No.: 16/075,164

(22) PCT Filed: Apr. 19, 2017
(86) PCT No.: PCT/US2017/028331

§ 371 Date: Aug. 3, 2018

(51) Int. Cl. B29C 64/209; B33Y 30/00; B41J 29/13

(52) U.S. Cl. CPC B29C 64/209; B41J 29/13; B33Y 30/00

(57) ABSTRACT

A print head assembly for a printer is described. The print head assembly includes a print die and an offset shim to protect the print die when the print head assembly is disposed on a surface.

### BACKGROUND

A print head may be the part of a printer that ejects the fluids used in printing. Two-dimensional (2D) printers and three dimensional (3D) printers may consume large quantities of these fluids during the process of printing. As a result, printer manufacturers have made print heads consumable items. The print heads may be replaced by end users of the printers.

### DESCRIPTION OF THE DRAWINGS

Certain examples are described in the following detailed description and in reference to the drawings, in which:

FIG. 1 is an illustration of a print head assembly that includes offset shims to protect the print dies in accordance with examples of the present techniques;

FIG. 2 is an illustration of a print bar that includes offset shims to protect the print dies of a print head assembly in accordance with examples of the present techniques;

FIG. 3 illustrates the attachment of an offset shim that protects the print dies of a print head assembly in accordance with examples of the present techniques;

FIG. 4 is an illustration of a print bar showing the placement of the offset shims that protect the print dies of a print head assembly in accordance with examples of the present techniques;

FIG. 5 is a detail of the front offset shim that protects the print dies of a print head assembly in accordance with examples of the present techniques; and

FIG. 6 is a process flow diagram of a method of manufacturing an offset shim that protects the print dies of a print head assembly in accordance with examples of the present techniques.

### DETAILED DESCRIPTION

Techniques for protecting a print die are described herein. A print die may be the part of a printer that ejects fluids. For example, a print die in a 2D printer may eject ink from nozzles. In a 3D printer, a print die may eject the fluids, e.g., fusing agent and colorant, which are used in the 3D printing process. Print dies may be arranged in a print head assembly. A print head assembly may contain one print die. If numerous print dies are present, the print head assembly may be referred to as a print die array. As used herein, the term “print head assembly” includes a print die array.

A print head assembly may be replaceable by the end user. The end user may set a new print head assembly down on a surface prior to installation. The surface may be part of the printer or external to the printer. The print head assembly may sit on the print die(s) when resting on the surface.

Print dies may be made of silicon and may be very fragile. Print dies may be the lowest point of a print head assembly when the print dies are facing down. Accordingly, prior to installation, the print head assembly may be set down on a surface resting on the print dies. However, print dies may be susceptible to cracking or other damage when a print head assembly rests on the print dies. A cracked or damaged print die may render an entire print head assembly unusable.

The techniques described herein provide for offset shims that may protect print dies when a print head assembly is disposed on a surface. The offset shims are the lowest point of a print head assembly when the print dies are facing down. The offset shims may raise the print dies above the level of the surface so that the print head assembly does not rest on the print dies when the print head assembly is placed on the surface.

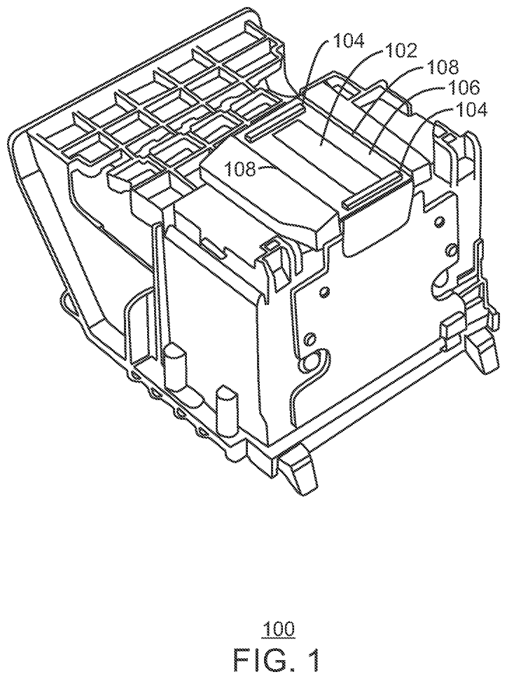

FIG. 1 is an illustration of a print head assembly 100 that includes offset shims to protect the print die. The print head assembly 100 may be from a small home or office printer or from a large-format printer, digital press, or 3D printer. The bottom of the print head assembly 100 is shown. The surface of the print head assembly shown in FIG. 1 may face down when the print head assembly 100 is installed in a printer.

The print die 102 may be the lowest point when the print die 102 is facing down. The print head assembly 100 may be removed to be cleaned by the end user or the print head assembly 100 may be a new print head assembly for installation in a printer. In either case, the end user may set the print head assembly 100 down on the print die 102. The result may be a cracked print die and an unusable print head assembly.

To prevent damage to the print die 102, the print head assembly 100 may include offset shims 104. The offset shims 104 may be the lowest points when the print die 102 is facing down. As a result, the offset shims 104 raise the print die 102 above the level of the surface so that the print head assembly 100 does not rest on the print die 102 when placed on a flat surface.

The offset shims 104 may be placed at the ends of the print die 102. The offset shims 104 may extend beyond the width of the print die 102, for example, for stability. Longer offset shims 104 may prevent the print head assembly 100 from tipping when the print head assembly 100 is sitting on the offset shims 104. Further, the offset shims 104 may be perpendicular to the print die 102 to prevent interference with the printing process. This placement may result in the offset shims 104 being disposed between the edge of the print die 102 and the edge of the shroud 106. To fit, the offset shims 104 may have a rectangular cross-section.

The offset shims 104 may be made of plastic as plastic may be easily formed into the shape of the offset shims 104. Plastic materials that may be used include polyacrylates, high-impact polystyrene (HIPS), polyphenylene sulfate (PPS), polyethylene terephthalate (PET), and the like. In some examples, though, the offset shims 104 may be made of ceramic or metal.

The offset shims 104 may attach to the shroud 106. For example, the offset shims 104 may snap over the edges 108 of the shroud 106. As another example, the offset shims 104 may be joined to the shroud 106 by an adhesive. A seal gasket may be placed between the offset shims 104 and the shroud 106 to fill any gaps between the offset shims 104 and the shroud 106.

The offset shims 104 may not be removable once attached. In these examples, the offset shims 104 remain attached to the shroud 106 after the print head assembly 100 is installed in a printer. However, the permanent placement of the offset shims 104 may limit the height of the offset shims 104. If the offset shims 104 extend too deeply into the printer, the offset shims 104 may interfere with the movement of the print head assembly 100 across the print medium.

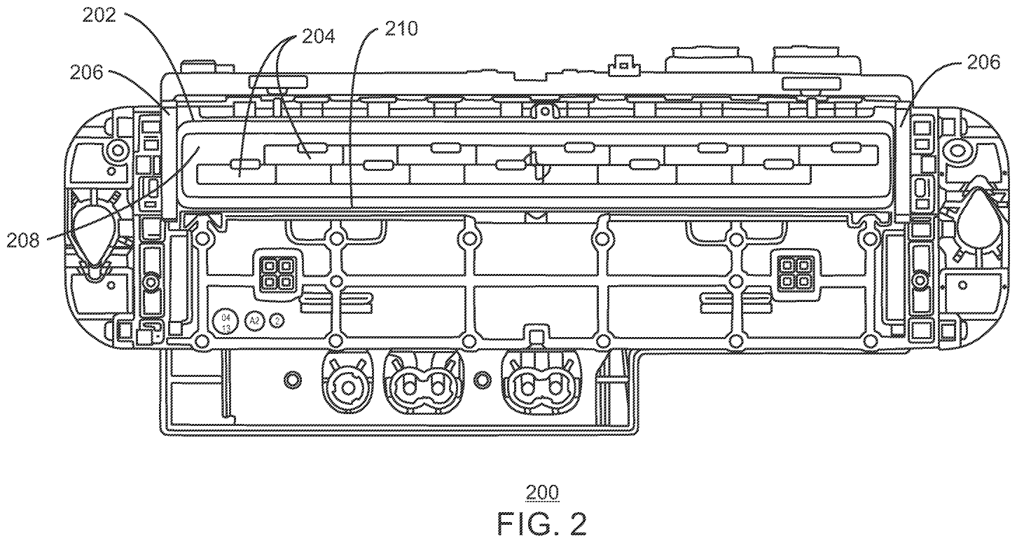

FIG. 2 is an illustration of a print bar 200 that includes offset shims to protect the print dies. The bottom of the print bar 200 is shown. The surface of the print bar 200 shown in FIG. 2 may face down when the print bar 200 is installed in a printer. The print bar 200 may, for example, be from a large format printer or 3D printer. In this example, the print bar 200 includes a print bar array 202 that includes a plurality of print dies 204. To simplify FIG. 2, not every print die is labeled. Offset shims 206 may be disposed at the ends of the print bar array 202. The offset shims 206 may be arranged perpendicular to the print bar array 202. The offset shims 206 may have a rectangular cross-section to minimize interference with printing or cleaning operations inside the printer. The location, size, and shape of the offset shims 206 may be determined by the limited space available on the bottom of the print bar 200.

The offset shims 206 may not be removable once attached. Accordingly, the offset shims 206 may remain in place on the shroud 208 after the placement of the print bar 200 in a printer. The permanent placement of the offset shims 206 may limit the height of the offset shims 206. If the offset shims 206 extend too deeply into the printer, the offset shims 206 may interfere with the printing process. With a 3D printer, the offset shims 206 may contact the powder used to generate a 3D object. The offset shims 206 may be short enough to raise the dies about 500 micrometers (μm) to 700 μm off a surface.

The offset shims 206 may serve another function in addition to protecting the print dies 204. The offset shims 206 may limit the interference of the wiper roller with the shroud 208 during an automatic wipe of the print dies 204. The interference may be limited by contact between the offset shims 206 and the wiper roller. Accordingly, the shroud 208 may be protected by the offset shims 206 because the wiper roller contacts the offset shims 206 instead of the shroud 208.

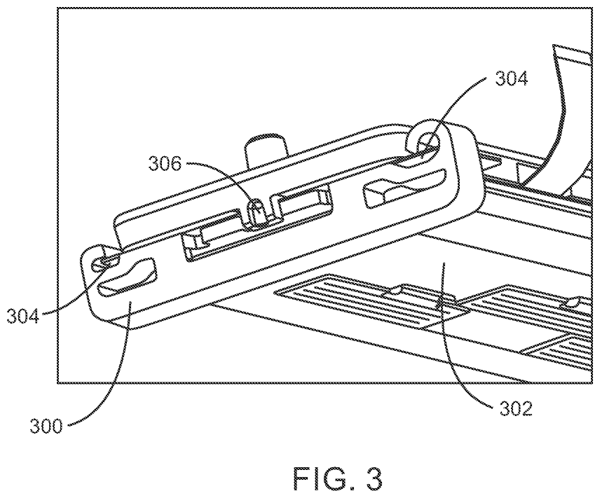

FIG. 3 illustrates the attachment of an offset shim that protects the print dies. The offset shim 300 may attach to the shroud 302. For example, the offset shim 300 may snap over flanges 304 on the shroud 302. The offset shim 300 may be retained in place by a tab 306. Alternatively, an adhesive may join the offset shim 300 to the shroud 302. Gaps between the offset shim 300 and the shroud 302 are filled by the seal gasket 210 shown in FIG. 2.

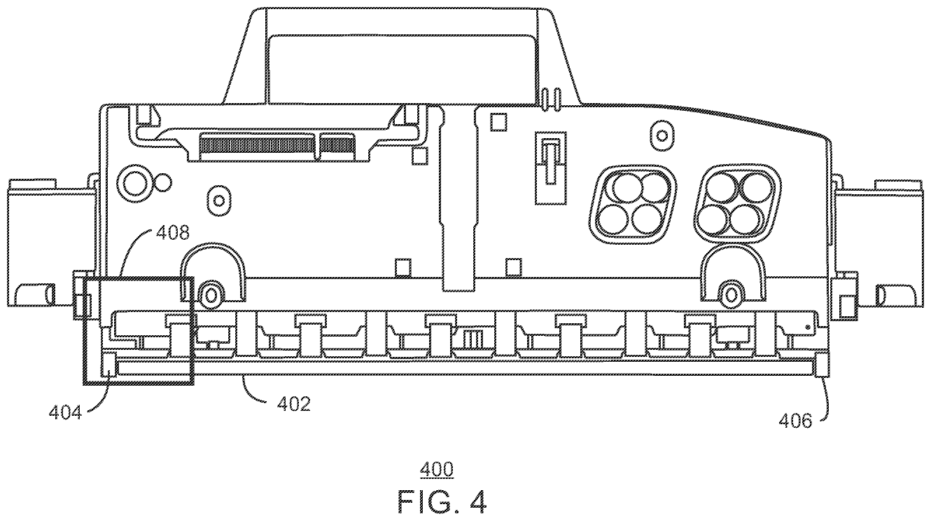

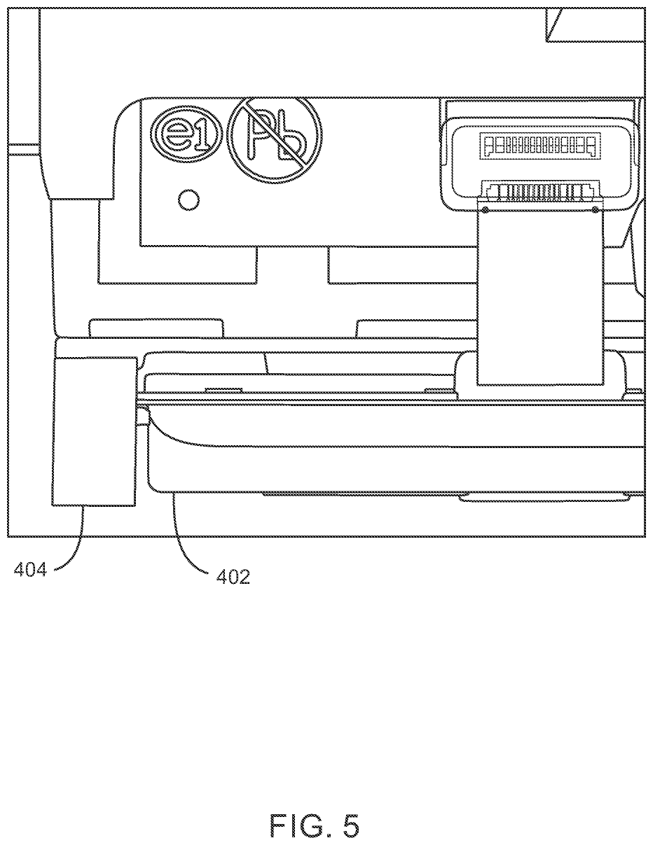

FIG. 4 is an illustration of a print bar 400 showing the placement of the offset shims that protect the print dies. The side of the print bar 400 is shown. The print bar 400 may include a plurality of print dies 402, a front offset shim 404, and a rear offset shim 406. The area in square 408 is shown in FIG. 5.

FIG. 5 is a detail of the front offset shim 404 in FIG. 4. The rear offset shim may have a similar configuration. Like numbered items are as described with respect to FIG. 4. The front offset shim 404 may be lower than the print die 402. The front offset shim 404 and the rear offset shim may be the lowest points of the print bar. As such, the offset shims raise the print dies above the level of the surface on which the print bar rests. Consequently, an end user of a printer may set the print bar on a surface prior to installation without damaging a print die.

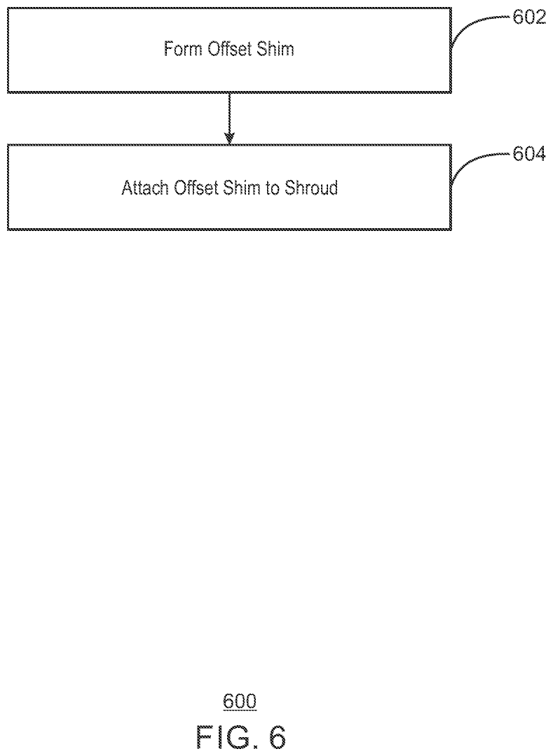

FIG. 6 is a process flow diagram of a method 600 of manufacturing an offset shim that protects the print dies of a print head assembly. The method 600 begins at block 602 when the offset shim may be formed. The method used to form the offset shim may depend on the material of construction. An offset shim may be made of plastic, ceramic, metal, and other suitable materials. If the offset shim is made of plastic, the offset shim may be formed by injection molding, machining, thermoforming or other methods for forming plastics. Injection molding is a manufacturing process for producing plastics parts by injecting plastic into a mold. Thermoforming is a manufacturing process in which a plastic sheet is heated until pliable, formed to a specific shape in a mold, and trimmed to create a usable product.

If the offset shim is made of ceramic, the offset shim may be formed by a manufacturing process that combines forming with sintering. Ceramics start as a mixture of powdered base material, binders, and stabilizers. Forming is accomplished by pressing, extruding, injection molding, and the like. The formed mixture is fired, or sintered, at high temperature.

If the offset shim is made of metal, the offset shim may be formed by metal injection molding (MIM) and other metalworking processes. MIM is a process in which finely-powdered metal is mixed with a measured amount of binder material to form a feedstock that is subjected to injection molding. Other metalworking processes may include casting, forming processes, cutting processes, and joining processes.

At block 604, the offset shim may be attached to the shroud of a print bar. The attachment of an offset shim to the shroud is shown in FIG. 3. As discussed with respect to FIG. 3, the offset shim may snap over flanges on the shroud. The offset shim may be retained in place by a tab. Alternatively, an adhesive may join the offset shim to the shroud.

The method 600 may include any number of additional blocks not shown in FIG. 6, depending on the details of the specific implementation. For example, additional blocks may include disposing the offset shim at an end of the print die and disposing the offset shim perpendicular to the print die.

While the present techniques may be susceptible to various modifications and alternative forms, the examples discussed above have been shown only by way of example. It is to be understood that the techniques are not intended to be limited to the particular examples disclosed herein. Indeed, the present techniques include all alternatives, modifications, and equivalents falling within the scope of the present techniques.

What is claimed is:

1. A print head assembly for a printer, comprising:
a print die and
an offset shim to protect the print die when the print head assembly is disposed on a surface.

2. The print head assembly of claim 1, wherein the print head assembly is removable from the printer, and wherein the print die is exposed when the offset shim is present.

3. The print head assembly of claim 1, wherein the offset shim comprises plastic, ceramic, or metal, or combinations thereof.

4. The print head assembly of claim 1, wherein the offset shim attaches to a shroud of the print die.

5. The print head assembly of claim 4, wherein the offset shim snaps onto the shroud of the print die.

6. The print head assembly of claim 4, wherein an adhesive attaches the offset shim to the shroud of the print die.

7. The print head assembly of claim 1, wherein the offset shim is disposed at an end of the print die.

8. The print head assembly of claim 1, wherein the offset shim is disposed perpendicular to the print die.

9. The print head assembly of claim 1, wherein the offset shim is the lowest point when the print die is facing down.

10. The print head assembly of claim 1, wherein the offset shim has a rectangular cross-section.

11. The print head assembly of claim 1, wherein the offset shim remains disposed on the shroud of the print die after placement of the print head assembly in the printer.

12. A method for manufacturing an offset shim, comprising:
forming the offset shim and
attaching the offset shim to a shroud of a print die.

13. The method of claim 12, wherein the offset shim attaches to the shroud by snapping into place.

14. The method of claim 12, comprising disposing the offset shim at an end of the print die.

15. The method of claim 12, comprising disposing the offset shim perpendicular to the print die.
